(19) United States
(12) Patent Application Publication
(10) Pub. No.: US 2015/0073839 A1
(43) Pub. Date: Mar. 12, 2015

(54) METHOD, APPARATUS, AND PROGRAM FOR AUTOMATING TRAVEL AGENCY

(71) Applicant: HAIDAR SUROOR MEJBIL ALHARBI, Sabahiya (KW)

(72) Inventor: HAIDAR SUROOR MEJBIL ALHARBI, Sabahiya (KW)

(21) Appl. No.: 14/020,967

(22) Filed: Sep. 9, 2013

(51) Int. Cl. G06Q 50/14; G06Q 10/02

(52) U.S. Cl. CPC G06Q 50/14; G06Q 10/02
USPC 705/5

(57) ABSTRACT

An apparatus, method, and program for automating a Travel Agency which facilitates the end user to book and issue the tickets in commercial travel engagement by the user himself without delay and errors, in turn reduces the total operating cost of travel agency by reducing/avoiding the intervention of agents in the process. The invention makes use of the document reader to read the international travel documents and a thermal printer to print the compact size of the ticket in addition to the touch screen monitor that allow the users to interact with the system.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates to the field of commercial travel ticket sales by travel agency. In particular, the present invention relates to booking and issuing of the tickets by minimizing the human interventions and reducing the possibility of errors and delays.

### BACKGROUND OF THE INVENTION

The current system has two versions; one is the normal travel agencies serving walking customers and the other is the online travel agencies. The travel agencies serving the walking customers are dealt with travel agents. So the customer will not have any kind of access to their system to see the details of the fare details. Also the system that the travel agent uses, will not give a clear picture to the customers as it is in specific codes such that only a trained person can understand it fully. The booking process is also never been easy. The agent can search for a fare and hold the seat for a very few minutes as the supplier systems like airline system do not allow any agencies to hold their seats for more than a specific time; normally 3 minutes. If the travel agent is not that much quick in entering the details of the passengers, the seat held for that travel will be lost. The travel agent can make mistakes while entering the data. Since the passenger's document data entered is critical to create booking, any small mistake will affect the trip. Normally this happens, particularly when there are many more passengers.

The other version is the online travel agencies, where it removes some of the limitations of the normal travel agencies. It will show the fare details to the customer in a very compact, easy to understand, attractive formats. Since it presents a large quantity of data and also the mechanism that allows end user sorting out and filtering the best fare from the results, it is more appropriate, compared to the normal travel agencies. But here also the problem persists as in the other version, to enter the passenger document details. If the customer fails to enter the passenger's document details within a definite time, the GDS Session provided by the airlines expires and the seat will be lost. If there are many more passengers the probability of mistakes increases. The chances of making mistakes are 30% to 40% more than that of a travel agent.

Another drawback of the online travel agency is that a huge number of persons still reluctant to use online payment gateways for security reasons. So the intensions of the online travel agencies are not being fulfilled almost all the times, as the transactions ends up only in searching the fares. The market strength for the online travel business varies on different geographical locations.

Accordingly, it would be desirable for the present invention to facilitate clients of the system to get quick, robust, error proof and guaranteed services; and assure investor of a satisfactory return to their investment, thus reducing and eliminating altogether the financial risks.

It is another desire of the invention to facilitate the investor to have multiple systems that can be placed within a local network or can be placed in multiple local networks in different locations, connected with the host server by proper communication channels. This would be more beneficial in economical terms if the investor has many more travel agencies in different areas or if he plans for that.

### SUMMARY OF THE INVENTION

The embodiments of the present invention solve the problems and address the drawbacks of the approaches in the above description. An embodiment of the present invention is a method of determining commercial travel ticket booking and issuing event by the Client system, where the Client system can be defined as a computer processor which has an interface for the end user to interact with the total system.

The preferred method comprising the steps of: scan the traveler documents of all the passengers, select the passengers who want to travel from the traveler list populated just after scanning the traveler documents, search for the fare, sort the fare and select the fare, book the selected fare, make the payment using debit card or credit card payment gateway, issue the ticket after successful payment, print the ticket if the vendor system responses with success message. The vendor system also referred as GDS which can be expanded as Global Distribution System and can be defined as a reservation tool travel agents use when make air, hotel, car, cruise and other travel service booking.

Another embodiment of the invention is the method to read the travel documents of the passengers using an electronic Document Reader and filter the data for validation and filling the relevant fields required by the GDS to create Passenger Name Record, referred as PNR, which is used for the future reference by the GDS. The method can send and receive acknowledgement between the Document Reader device and the Client system and will allow the Client system to have the total control over the Document Reader.

The Client system will always be connected to the GDS. Yet another embodiment that involves in the invention is the Host server, which will be a web server computer connected to the database with appropriate software to communicate with the Client system over a secure SSL connection.

A further embodiment of the present invention is the method to interact with the printer. If any ticket has been issued, the method may be invoked by the Client system and may send information to the printer to print the issued ticket. The printer will print the ticket in a compact size and the automatic cutter attached to the printer may cut the paper once the printer finishes printing, based on the instruction from the method.

These and other embodiment of the present invention is further made apparent, in the remainder of the present document, to those of ordinary skills in the art.

### BRIEF DESCRIPTION OF DRAWINGS

In order to more fully describe embodiments of the present invention, reference is made to the accompanying drawings. These drawings are not to be considered limitations in the scope of the invention, but are merely illustrative.

FIG. 1 shows the overall architecture of the system with the preferred embodiments. It will depict how the major components required by the system, are connected together.

FIG. 2 shows the major components of the Clients System.

FIG. 3 shows a method overview of the preferred embodiments of the present invention.

FIG. 4 shows a flowchart depicting the processing of the system from the initial request to open the system to the issuance of the ticket and printing the ticket.

### DETAILED DESCRIPTION OF SPECIFIC EMBODIMENTS

The description and drawings are for the purpose of illustration not limitation. Those of ordinary skill in the art will recognize variations, modifications, and alternatives. Such variations, modifications and alternatives are also within the scope of the present invention. Section titles are effectively concise and are for convenience only.

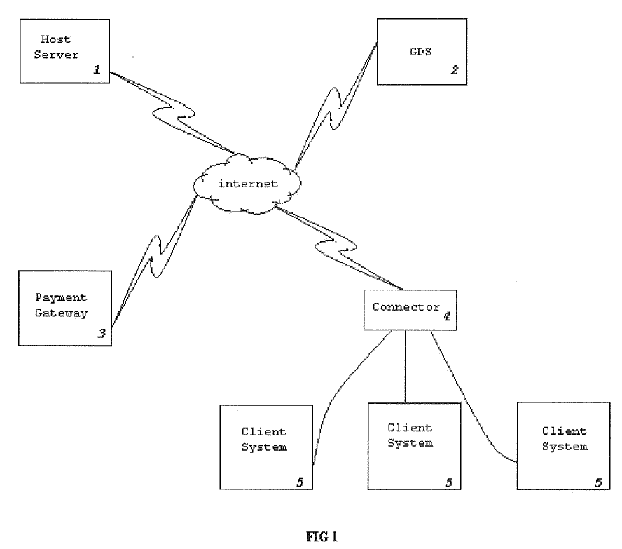

Referring to FIG. 1, there shown the overall architecture of the system diagram of a preferred embodiment of the present invention. In this embodiment, at least one or more Client systems 5 are connected to the Host server 1 by a suitable system interface. Client systems 5 may be adapted to communicate to external devices via a network connection, hard wire connection, wireless connection or any other connection, and provides customers access to the services. In one embodiment of the invention, the only external device that enables the customers for communicating with the whole system is the Client system 5. This terminal may be adapted to receive request directly from the users to purchase the ticket. There can be one or more terminals or Client systems in one premise connected to the total system through an external device Connector 4, this may be a single or combination of multiple devices, like switch, router etc.

The system depicted in FIG. 1, may be embodied in hardware specifically provided to implement the present invention. The system may be implemented using the infrastructure that links with any of the Global Distribution Systems, indicated as GDS 2 in figure. Host Server 1 may be a web server computer connected to a database with appropriate software to communicate with the external devices and implement the required methods.

Another embodiment of the present invention is the Payment Gateway 3, depicted in FIG. 1 that may be connected to the system, to enable the users to purchase the ticket, through a proper and secured communication channel. Host server may implement certain methods to validate the data transfer through the payment gateway 3.

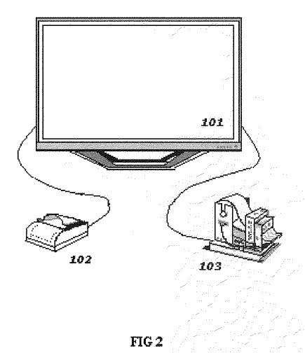

FIG. 2 depicts the major components of the Client system that plays vital roles in the ticketing process. In a preferred embodiment, a computer 101, with a touch screen monitor incorporating appropriate software programs helps the users to interact with the system. A Document Reader 102 is connected to the computer 101 in the Client system via a hard wire connection, wireless connection, a network connection or any other connection, that provides the facility to the user to scan the relevant travel document such as International Passport or National Civil IDs. In a preferred embodiment of the present invention, the Client system incorporated with methods, to make the Travel Document Reader ready to allow the user to scan the documents, manipulate the information that have been read from the document, and instruct the Document Reader to go inactive mode. FIG. 2 also shows a Thermal Printer 103 that prints the ticket information. Another embodiment of the present invention involved in controlling the Thermal Printer using methods that may be incorporated to the computer as programs, like sending the print information to the printer and triggering the print event to the print the electronic ticket and for cutting the paper once the print is finished.

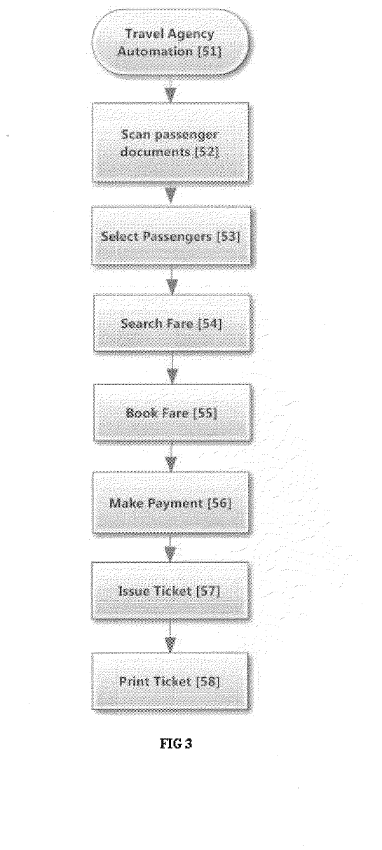

The preferred method as shown in FIG. 3 comprises the steps of Scan the passengers travel documents 52, select the passengers from the list of scanned documents to book their seats 53, enter the search criteria and search for the fare 54, from the list of resultant fares and details, select one fare to book that fare 55, make the payment to issue the ticket via the payment gateway integrated 56, issue the ticket 57, and print the issued ticket 58.

The transaction may be initiated from any one of the Client system 5 linked to the GDS 2 and Host Server 1. The information required to implement the transaction may be passed between the Client system 5 and the GDS 2. The Host Server 1 provides the relevant information to the Client system 5 to fulfill the transactions and keeps track of all the transactions in the system.

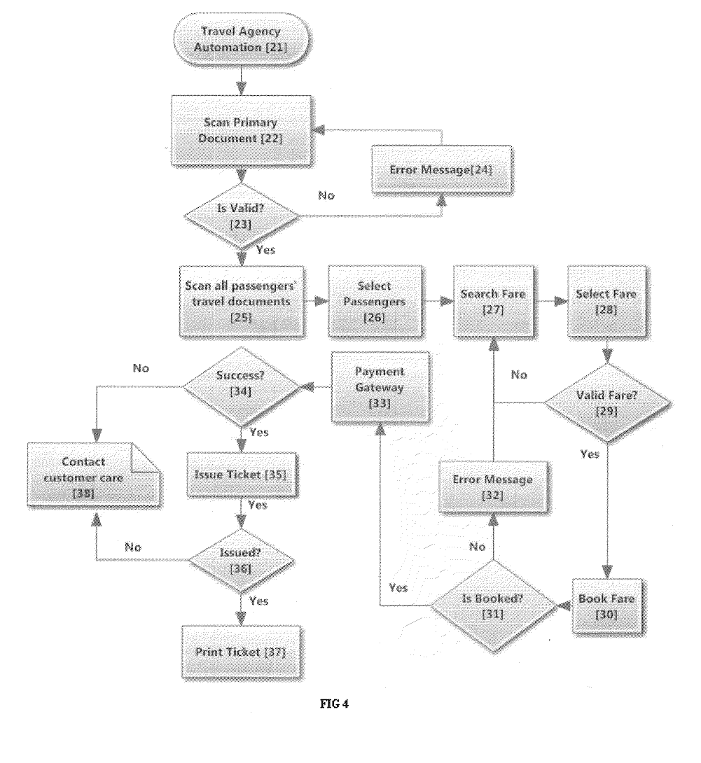

FIG. 4 is a flowchart depicting the processing of the customer request. The process starts when a customer accesses any of the Client systems 5 and scans his international travel document 22. The travel, document which one is scanned first by a customer could be treated as the Primary Travel Document by the system for the future reference and mapping it in the Host server database. There could be more than one passenger to participate in a trip, so for future references the system points to the first travel document as the primary document. The system implements validation methods to invalidate the primary travel document 23. If the document fails in the validation procedures, the system would show the error message to the user 24, and blocks the user to move forward until he could be able to submit a valid travel document. The travel document validations include: type of document like e-Passport and National Civil IDs, whether the document has MRZ inscription or has built in Contact chip etc. The primary objective of the validation is to check whether the data retrieved from the travel document fulfills the requirement of the GDS standards. This validation may be performed on each traveler document at the time of scanning by the Document Reader. Once the primary document has been read successfully the system will open the next step to the user to scan all the other traveler documents who participate in the journey 25. The details of the scanned documents will be presented in a way that the user would be able to view the passenger details and can select the passenger one by one. Now the user can select the passengers from the list 26. The system may implement some validation criteria here to validate the number of passengers and type of passengers who participate in the trip according to the GDS 2 standards. Once the passengers are being selected by the user, the Client system 5 will provide an interface to search for the fare, where he needs to input data into certain fields like airports and dates, and may select some options like type of the trip, direct flights etc and can search for fare 27. The request will be passed from Client system 5 to the GDS 2 through proper channel and the Client system 5 get response from the GDS 2 that will be formatted according to the specific standards by the methods incorporated in the Client system 5, so that the user can sort out the resultant data and can select his choice of fare 28. Since the availability of the fare with the GDS 2 may change in each second, the validation method incorporated in the Client system 5 checks the availability of the selected fare with the GDS 29. If still the fare exists with the GDS, the Client system will send request to the GDS to book the fare 30. The booking will be resulted in a booking number also referred to as PNR number for future reference by the GDS. If the booking has been resulted in PNR Number 31, the Client system will redirect the user to the payment gateway through the Host server 33 else will be resulted in Error Message 32 and lead the user to the Search Fare 27 area. If the payment transaction has been finished successfully 34, the system has to issue the ticket with the GDS 35, As the Client system gets the response from the GDS that the ticket has been issued 36, the Client system triggers the printer connected with the Client system to print the ticket 37. If the GDS returns the response that the ticket has not been issued then the Client system would ask the user of the system to contact the Customer Care 38.

The Host server 1 will be acted as a resource to the Client system 5 as it provides all the necessary information and updates. The Host server 1 will be connected with a database, which will be acted as the central database that can be accessed by all Client systems 5 connected to the system, keeps track of all the transactions made by the Client system 5 and keeps the user's travel document data. The preferred embodiment of the present invention is a method to synchronize certain data with the Host server 1 and the Client systems 5. In order to provide a faster access to the information to the user, the Client system 5 also keeps some relevant data on its own local machine so as to reduce the data flow between the Host server 1 and Client systems 5. Once a data file has been modified on the Host server 1, this modification should be replicated to the same file resides on the Client systems 5, for that a notification should be send from the Host server 1 to the Client system S and the synchronization may be performed. This replication and synchronization may be performed when the Client system 5 is in offline mode.

Even though the major transactions are performed between the Client system 5 and the GDS 2, a preferred embodiment of the present invention, a method called Transaction Log method, incorporated in the Client system 5 may log each transaction with a signature of the Client system 5 and pass it onto the Host server 1. The specific methods included in the Host server 1 application may arrange these data and save it on its database for future references. In a nutshell the application resides on the Host server 1 will be able to provide each of the Client system's 5 activities to the investor or the administrator of the system. The application on the Host server 1 will have an administrator area to view the detailed reports of Client system's 5 activities.

The minimum required components of the Client system 1 consists of a computer processor with a touch screen monitor 101 connected with a document reader 102 and a printer 103. For inputting the data, the system provides a virtual keyboard with the program and the availability of the virtual keyboard may be restricted to some specific input fields.

One preferred embodiment of the system is the method to create a record corresponds to each traveler in the Host server 1 which comprises of the necessary fields extracted from the international travel document by the Document Reader 102. The extracted fields will be displayed to the user for making sure that the data are correct to the best of his knowledge. An agreement should be created between the user and the system that the user agrees that the data are correct, before moving to further steps. The system allows the user to start searching for the fare only when the user has assigned a session to use the service. The method included in the system would create a session for the user to use the system if and only if his profile has been created. The method incorporated in the system will create the Profile Record when the system accepts the primary document information and also the mobile number. The first-name extracted from the travel document and mobile number the user entered may be used in a combination to form the primary key for the profile record and keep it in the Host server 1 database for future reference. The profile record may include records of one traveler or a group of travelers. Once the profile record has been created, the system can accept a limited number of travelers' details, provided that this number may be initialized by the investor or administrator of the system. An option provided by the program would ask the user to add other travelers' document details to the system by scanning the documents. The user can now scan the document as much as the system allows. Each time a travel document is scanned the Client system 5 will read the document and show the filtered data in a record so that the user can check and add that the record to the Profile Record.

The necessity to keep the Profile Record is to make the workflow much easier next time the user wants to issue a ticket. Even though the system holds a valid profile record of a particular user, the user needs to use the same registered document to scan and his registered mobile number to open and access his previously stored record. One of the preferred embodiments of the present invention is a method to check the Host server 1 database whether a Profile Record exists for the scanned document data and the mobile number that has been input by the user. If the profile record exists, the method will list all the traveler records, corresponds to that primary document and mobile number, from which the user will be able to select the passengers for the current trip.

Another preferred embodiment of the invention is a method to classify the passengers of a profile record based on different criteria. The classification may be based on the Date-of-birth scanned from the travel document to find the type of passenger like Adult, Child or Infant. Another classification may be based on the type of document used for travelling, for example electronic passport or national civil id. Yet another classification is the gender of the travelers. The method incorporated in the system will process the scanned data such as date-of-birth, gender to set the title for each passenger. The method filters these basic details from the data retrieved by the Document Reader 102 because these are the standard data that should be provided to the GDS 2 for making a reservation of a commercial travel ticket. The method will calculate the number of Adults, Children and Infants in a Profile Record.

The user will be displayed the total travelers in a list format in such a way that there is an option against each traveler record for selection, once the method in the Client system 5 could identify the user from the profile records resides in the Host server 1. The user can select the passengers from the list for the trip by the option provided by the Client system 5. Now the user can search the fare for a destination by entering his port of travel and desired destination port with the dates of travel. The validation method incorporated in the Client system 5 would validate the selections and convert the search parameters collected into a proper request to the GDS 2 according to its standards and wrap the request with secured socket layer token. The Client system passes this request to the GDS through a highly secured communication channel. The transaction log method will record this transaction and keep it in the Host server 1 database. A method incorporated in Client system 5 will arrange the data returned from the GDS 2 in a way that the user can sort and filter different fares. The user will be able to select any one of the results for reserving the fare.

The selection of the fare may send another request to the GDS 2 to seek about the availability of that fare and if available, another request may be send to the GDS 2 to book that fare. Booking of the fare requires all the relevant information of the passengers' details that may be retrieved from the Profile Record or from the Document Reader 102. The GDS 2 response will include a reference number referred to as PNR Number if the booking has been done correctly else an error status message will be resulted and the system will take the user to the area of fare search back. The Client system 5 sends this PNR details to the Host server 1 and the Host server 1 keeps it in its database.

Once the PNR Number has been created the Client system 5 method will lead the user to the Payment Gateway 3. The Payment Gateway 3 can be supporting either Debit Card transaction or Credit Card transaction or both. For the payments, the architecture of the present invention supports to perform the transactions within the Host server 1. The Client system 5 may not have direct access to the Payment Gateway 3, according to the workflow. Each payment transaction would be initiated from the Client system 5 and pass the payment request to the Host server 1 with the appropriate payment parameters encrypted in the transport layer with the SSL (Secured Socket Layer) certificate. One preferred embodiment of the present invention is a method which is incorporated in the Host server 1 program to validate the payment request from the Client system 5 and if the validation is successful, the method may carry the user to the Payment Gateway 3.

This payment architecture will avoid the complexity of integrating the Payment Gateway 3 with multiple Client systems 5. Since each Client system 5 has definite secure communication path with the Host server 1 it can initiate the payment transaction and can virtually access the Payment Gateway 3 through the Host server 1. Another advantage of this payment architecture is that, this will be suitable for some payment gateways which require web servers to initiate the payment transactions with appropriate user permissions. Since the Client system 5 may not be running under a web server, the possibility is to make use of the web server within the Host server 1. Any responses from the Payment Gateway 3 will be passed to the Client system 5 by the Host server 1 and the Client system 5 presents it to the user with proper messages.

Once the payment has been done successfully a notification with response parameters will be passed by the Host server 1 from the Payment Gateway 3 to the Client system 5 and the Client system 5 will send subsequent requests to issue the ticket with reference to the PNR Number. The GDS 2 will return the response with ticket and other details if the ticket has been issued successfully. A method embodied in the present invention, would trigger the printer connected to the Client system 5 to print the ticket details in a very compact format.

Yet another embodiment of the invention is a method executed when exception occurs while issuing the ticket. This method may be executed either if the Payment Gateway 3 returns exception as the payment transaction fails or if the GDS 2 returns error message that Ticket was not issued. In both these cases the Client system 5 shows a friendly message to the user to contact the Customer care with the PNR Number that has been issued while the reservation performed.

Although specific embodiments of the present invention have been described above in detail, the description is merely for purposes of illustration. Various modifications of and equivalent steps corresponding to, the disclosed aspects of the exemplary embodiments, in addition to those described above, can be made by those skilled in the art without departing from the spirit and scope of the present invention, the scope of which is to be accorded the broadest interpretations so as to encompass such modification and equivalent structures.

What is claimed is:

1. A computer-implemented method of determining a booking and issuing a travel ticket by the method comprising:
executing, using one or more computer systems, executable instructions to perform steps comprising:
reading the passengers' travel documents such as International e-Passports and National Civil IDs by triggering the Document Reader connected to the Client system to read the travel document;
method to list out all the passengers whose travel documents has been read through the Document Reader with an option to select passengers against each passenger record;
searching the fare with the selected passengers from the list whose travel documents are being read;
book one of the fares for the selected passengers and submit the PNR reference number;
make the payment for that booking using one of the Payment Gateway integrated with the Host server;
issue the ticket if the payment has been done successfully with the GDS;
method incorporated in the Client system to trigger the printer to print the compact size of the ticket if the ticket has been issued successfully.

2. The computer-implemented method according to claim 1, wherein the process of reading the travel documents of the passengers in such a way that, the first travel document that the traveler scans using the Document Reader, would be considered as the Primary Travel Document for the booking process by the Client system and the Passenger in that Primary Travel Document will be considered as the user of that booking process.

3. The computer-implemented method according to claim 1, wherein the method accepts the user's mobile number and the mobile number in conjunction with the document details of the Primary Travel Document that have been read by the Document Reader at first time, will create a Profile Record in the Host server with a primary key for the future references.

4. The computer-implemented method according to claim 1, wherein the Client system will create a User Session for the current user once the Profile Record has been created in the Host server or the method incorporated with the Client system could find the Profile Record for the current user in the Host server as far as the Primary Travel Document has been scanned by the Document Reader and the mobile number has been submitted by the current user.

5. The computer-implemented method according to claim 1, wherein the Client system provides the user a facility to add multiple passenger details as much as the system allows by scanning the travel document of each passenger one by one, and append it to the Profile Record.

6. The computer-implemented method according to claim 1, wherein a method incorporated with the Client system which validates each of the travel document details extracted by the Document Reader from the document like e-Passport or National Civil IDs, to validate the details to check whether the details satisfy the GDS standards to make the reservation. If the validation fails, the method doesn't allow the system to receive that document to add to the Profile Record and show the message to the user to add a valid document.

7. The computer-implemented method according to claim 1, wherein a method incorporated with the Client system that sends each passenger records to the Host server as the user appends that document details to the Profile Record if the validation procedure claimed in the claim 6 was successful, and the Host server adds this record to the database mapped with the primary key for future references.

8. The computer-implemented method according to claim 1, wherein a method incorporated with the Client system that lists out all the passenger records in a grid with an option to select each passenger who participate in the trip.

9. The computerized system according to claims 2 and 5, wherein the system scans and add the traveler details to the Profile Record in such a way that, a method incorporated in the Client system will classify the data, read by the Document Reader from the traveler's valid travel documents based on certain criteria such as the Travel Document Type, Gender and Date-of-birth. This classification of data is important according to the GDS standards to submit the request to make reservation.

10. The computerized system according to claim 4, wherein the user can access all the associated travel documents from the Host server database if the Profile Record associated with his travel document and mobile number exists. The method incorporated in the Client system would search for such a combination of Primary Travel Document details and mobile phone number once the user enters into the system. If combination exists in the Host server database, the method will list the travel documents details on grid with an option of selecting the passengers for the current ticket reservation process.

11. The computerized system according to claim 2, wherein a validation method incorporated with the Host server checks the database for the similar Profile Record to avoid duplication.

12. The computer-implemented method according to claim 9, wherein the method incorporated in the Host server, filter the document details to count the Adult, Child and Infant passengers and save it in the database.

13. The computer-implemented method according to claim 9, wherein the method incorporated in the Host server, filters the document details to set the Title of each passenger to MR, MRS, MISS, MSTR etc by processing the data like Date-of-Birth and Gender read by the Document Reader.

14. The computerized system according to claim 1, wherein the payment transactions may be performed in the Host server where the Client system passes the required payment parameters to the Host server and request for payment. The Host server selects Payment Gateway and makes the payment there and returns the resultant parameters to the Client system.
